(19) United States
(12) Patent Application Publication
(10) Pub. No.: US 2004/0178732 A1
(43) Pub. Date: Sep. 16, 2004

(54) Assembly for lamp construction and associated lamp and method for connecting the assembly

(75) Inventor: Bodo Mittler, Stadtbergen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN mbH, MUNCHEN (DE)

(21) Appl. No.: 10/787,588

(22) Filed: Feb. 27, 2004

(30) Foreign Application Priority Data
Mar. 14, 2003 (DE) 103 11 305.3

(51) Int. Cl. H01J 17/04; H01J 61/04

(52) U.S. Cl. 313/633; 313/623; 313/631

(57) ABSTRACT

An assembly for lamp construction, comprising a solid W component (10) and at least one film (9) having two contact faces, comprising a metallic molybdenum base body and a coating, which is applied at least in part to said base body and which comprises ruthenium or rhenium alone or as an alloy in the region of the first contact face, which produces the contact with the W component, whereas the second contact face is not coated and is intended to be in contact with glass.

### TECHNICAL FIELD

The invention relates to an assembly for lamp construction and an associated lamp, and a method for connecting the assembly. The assembly for lamp construction is comprising a solid component, which is largely made of tungsten and is referred to below as a W component, and at least one molybdenum film which has two contact faces, of which a first contact face is in contact with the W component. The invention relates in particular to high-pressure discharge lamps having a metal halide filling for photo-optical purposes, but also to other types of incandescent lamps and discharge lamps, for example xenon lamps.

### BACKGROUND ART

An assembly for lamp construction and an associated lamp and a method for connecting the assembly has already been disclosed in DE-A 196 18 967. Here, the glass component is referred to as a securing component. This component, which is often also referred to as a supporting roll, is fixed by means of a molybdenum stopper, evidently a wire. The stopper is clearly simply pushed onto the electrode rod, but cannot be fixed, since molybdenum cannot be welded to solid tungsten.

A similar technique is disclosed in U.S. Pat. No. 6,262,535. Here, the supporting roll is fixed owing to its conical shape, and owing to the fact that the neck of the discharge vessel bears closely against the supporting roll.

### DISCLOSURE OF THE INVENTION

It is an object of the present invention to provide an assembly for lamp construction which is comprising a solid component, which is largely made of tungsten and is referred to below as a W component, and at least one molybdenum film which has two contact faces, of which a first contact face is in contact with the W component, which can be fixed in a simple and reliable manner. A further object is to specify a method for the production of such an assembly.

These objects are achieved by the following features: the film is coated on one side in the region of the first contact face, this coating comprising ruthenium and/or rhenium, whereas the second contact face is not coated and is intended to be in contact with glass.

The object of the method for producing an assembly between a molybdenum film and a solid W component is achieved by the following features: the film is provided on one side with a rhenium- or ruthenium-containing coating in the region of the contact face to the W component, and then the film is welded to the W component in the region of the contact face to an assembly having an electrically conducting connection.

Particularly advantageous refinements are described in the dependent claims.

The present invention develops further the possible solutions described in the teaching of U.S. Pat. No. 6,624,576 in that a molybdenum film (typically 100 μm thick) is coated on one side with pure rhenium or ruthenium or a mixture thereof or a compound comprising ruthenium or rhenium. Particularly suitable coating materials are pure ruthenium and a molybdenum/ruthenium alloy having a eutectic composition.

The thicknesses of the rhenium- or ruthenium-containing layer are preferably in the range from 0.02 to 1.0 μm. In a particularly preferred embodiment, the thickness is from 0.02 to 0.09 μm.

The coating may be carried out using known coating methods, preferably by sputtering.

The molybdenum films coated with rhenium or ruthenium or alloys thereof can be welded very effectively, in contrast to uncoated molybdenum films or molybdenum wires. The coated side of the molybdenum film can thus be welded directly to a solid W component, in particular a rod or a disk. The particular advantage is that different thicknesses and shapes of the W component are insignificant, since they can be provided with the same coated film, and that additional welding aids can be dispensed with.

In a preferred embodiment, one or more molybdenum films are welded directly to the solid W component, that is without the otherwise conventional welding aids such as tantalum or platinum. The component is made either completely or largely from tungsten; in this case it is slightly doped in the conventional manner, for example with aluminum or potassium.

In a further particularly preferred embodiment, the molybdenum films are used to fix a glass component by them being used on the solid W component as an interlayer between the latter and the glass component. The glass component is fixed by means of a fold, which is produced by pushing the part of the film which protrudes on the glass component together. The film is then welded to the W component.

The electric lamps according to the invention have a silica-glass or hard-glass lamp vessel, which is provided with—usually two—necks, in each of which there is a solid W component as part of the bushing. There is at least one molybdenum film on the W component with its coated side facing the W component and being welded to said W component.

A method for fixing a glass component is based on the production of a fold in the film, which can then serve the purpose of fixing the glass component. The molybdenum film, which is coated on one side, is then finally fixed to the W component by means of welding.

### BRIEF DESCRIPTION OF THE DRAWINGS

The invention is explained in more detail below with reference to two or more exemplary embodiments. In the drawing:

FIG. 1 shows a partial section through a metal halide lamp (FIG. 1a); and a perspective detail thereof (FIG. 1b); ANF

FIG. 2 shows a section through a further exemplary embodiment (FIG. 2a) and a side view thereof (FIG. 2b).

### BEST MODE FOR CARRYING OUT THE INVENTION

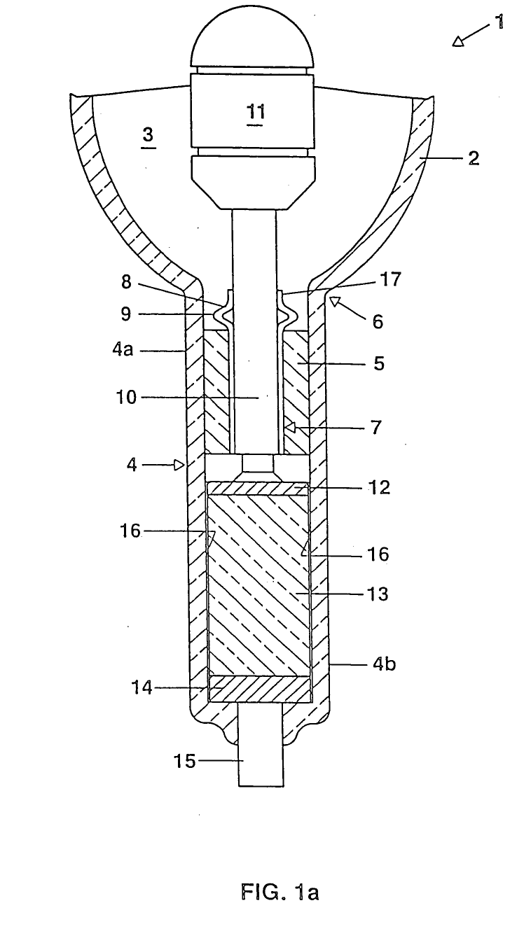

FIG. 1a shows a section through a mercury high-pressure discharge lamp 1 having an output of 2.5 kW. It has a silica-glass bulb 2 having a wall thickness of 4 mm. It is elliptical, in the form of a barrel, or the like, and surrounds a discharge volume 3. Connected to this, on both sides, diametrically opposite one another, are two bulb necks 4 (only one is shown), which each contain a seal. These have, in relation to the discharge volume 3, a front part 4a, which contains a cylindrical, silica-glass supporting roll 5, and a rear cylindrical part 4b, which forms the sealing-off seal. The front part 4a has a recess 6 of 5 mm in length. Connected to this is a supporting roll 5 having a hole 7, which is cylindrical, or else conical. Its inner diameter is 7 mm, its outer diameter is 15 mm. The wall thickness of the bulb is approximately 4 mm in this region. The axial length of the supporting roll is 22 mm.

An electrode rod 10, which is made of solid tungsten, has a diameter of 6 mm and reaches into the discharge volume, where it bears an electrode head 11 as the anode, is guided axially in the central hole 7 in the supporting roll. The rod 10 is extended to the rear beyond the supporting roll 5 and ends at a plate 12 which is adjoined by a cylindrical, quartz block 13. Behind this is a second plate 14, which holds an outer power supply line in the form of a molybdenum rod 15 in the center. Four molybdenum films 16 are guided, in a manner known per se, along the outer face of the quartz block and sealed in on the wall of the bulb neck. They are spot-welded to the tungsten plates 12 and 14.

The supporting roll 5 is fixed by means of four molybdenum films 8, which are distributed along the circumference of the W rod 10 (only two of which can be seen in FIG. 1). However, in principle, just two mutually opposing molybdenum films suffice for fixing purposes. The films 8 each have a fold 9, which fixes the supporting roll, see the detail drawing in FIG. 1b. The film 8 is welded, on the one hand, to the rod 10 at the end of said rod 10 which is remote from the discharge. Once the fold 9 has formed, the film 8 is also spot-welded at its end 17 which is initially still free. A particular advantage of this film is that it fixes the glass component or the supporting roll.

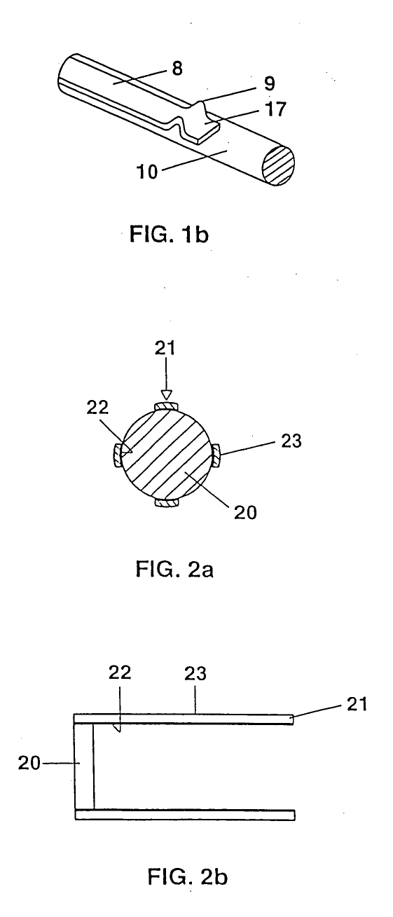

In a simple variant of the invention, the solid W component is a disk 20, see FIGS. 2a and 2b, to which the Ru-coated side 22 of the molybdenum films 21 is fixed. In this case too, preferably two or four films (FIG. 2b) can be distributed over the circumference of the disk 20. A welding aid, for example a tantalum film, is avoided in this manner. The second side 23 of the film 21 remains uncoated, so that the glass adheres here, resulting in a sealed connection between the quartz block and the bulb.

What is claimed is:

1. An assembly for lamp construction, comprising a solid component, which is largely made of tungsten and is referred to below as a W component, and at least one molybdenum film which has two contact faces, of which a first contact face is in contact with the W component, wherein the film is coated on one side in the region of the first contact face, this coating comprising ruthenium and/or rhenium, whereas the second contact face is not coated and is intended to be in contact with glass.

2. The assembly as claimed in claim 1, wherein the coating is made of pure ruthenium or rhenium or a rhenium or ruthenium compound or alloy, in particular a eutectic molybdenum/ruthenium alloy.

3. The assembly as claimed in claim 1, wherein the thickness of the coating is between 0.02 and 1.0 μm, in particular 0.02 to 0.09 μm.

4. The assembly as claimed in claim 1, wherein the W component is an electrode rod or a disk.

5. A lamp having the assembly as claimed in claim 1.

6. The lamp as claimed in claim 5, further comprising a hard-glass or silica-glass lamp vessel, which is provided at least at one end with a sealing-off extension and contains a luminous element and, possibly, a filling, the assembly being part of the seal.

7. The lamp as claimed in claim 5, wherein the lamp vessel has, in the form of an extension, a neck seal, the W component being an electrode rod.

8. The lamp as claimed in claim 7, wherein two electrodes, which are each held by means of an electrode rod, are positioned diametrically opposite one another in the lamp vessel, a supporting roll, which is fused to the bulb wall in the region of the bulb neck, surrounding each rod in the front part of the bulb neck, and at least one film, which has a fold bearing against the supporting roll for the purpose of fixing said supporting roll, being inserted between the supporting roll and the electrode rod.

9. The lamp as claimed in claim 8, wherein the free end of the film is welded to the electrode rod behind the fold.

10. A method for producing an assembly between a molybdenum film and a solid W component, wherein the film is provided on one side with a rhenium- or ruthenium-containing coating in the region of the contact face to the W component, and then the film is welded to the W component in the region of the contact face to an assembly having an electrically conducting connection.

11. The method as claimed in claim 10, wherein the W component is a rod or a disk.

12. The method as claimed in claim 11, wherein, for the purpose of fixing a glass component to a rod, the method is used such that the film is moved along a central axial hole in the glass component, and then the end of the film which still protrudes on the glass component is gathered to form a fold, which bears against the glass component, and then the remaining free end of the film is welded to the rod.

13. The method as claimed in claim 12, wherein either the film is introduced into the glass component or the glass component is pushed onto the film.
